(19) United States
(12) Patent Application Publication
(10) Pub. No.: US 2017/0216635 A1
(43) Pub. Date: Aug. 3, 2017

(54) A Support Device

(71) Applicant: SAS Safety System Holdings Pty Ltd, Southport (AU)

(72) Inventor: Paul Stibilj, Glenella (AU)

(21) Appl. No.: 15/500,501

(22) PCT Filed: Jul. 31, 2015
(86) PCT No.: PCT/AU2015/050430

§ 371 Date: Jan. 30, 2017

(30) Foreign Application Priority Data
Jul. 31, 2014 (AU) 2014208260
Jul. 31, 2014 (AU) 2014902968

(51) Int. Cl. A62B 35/00

(52) U.S. Cl. CPC A62B 35/0018; A62B 35/0025

(57) ABSTRACT

A support device for a harness includes a dorsal member configured for arrangement on a dorsal region of a wearer and for operative engagement with the harness in a position in which the dorsal member is interposed between straps of the harness and the dorsal region of the wearer, the dorsal member having an upper portion, a lower portion and an intermediate portion interposed between the upper and lower portions. A neck support member extends from the upper portion of the dorsal member and is configured to support a neck of the wearer when the dorsal member is arranged on the dorsal region of the wearer. The dorsal member has a profile that corresponds to a generic side profile of a thoracic spine of the wearer and the neck member extends backwardly from the upper portion of the dorsal member, such that the dorsal member can distribute pressure exerted by the straps and the neck support member can cradle the neck and support the head in a tilted back condition.

### FIELD

Various exemplary embodiments of a support device for a harness are described herein. Various exemplary embodiments of a harness incorporating a support device are also described herein.

### SUMMARY

Various exemplary embodiments of a support device for a harness comprise

a dorsal member, the dorsal member being configured for arrangement on a dorsal region of a wearer and for operative engagement with the harness in a position in which the dorsal member is interposed between the harness and the dorsal region of the wearer, the dorsal member having an upper portion, a lower portion and an intermediate portion interposed between the upper and lower portions; and

a neck support member that extends from the upper portion of the dorsal member and is configured to support a neck of the wearer when the dorsal member is arranged on the dorsal region of the wearer, wherein

the dorsal member has a profile that corresponds to a generic side profile of a thoracic spine of the wearer and the neck member extends backwardly from the upper portion of the dorsal member, such that the dorsal member can distribute pressure exerted by the harness and the neck support member can cradle the neck and support the head in a tilted back condition.

The dorsal member may have a side profile that extends back or outwardly from the upper portion to the intermediate portion about one third to a half of a vertical length of the dorsal member and then inwardly or forward to the lower portion.

The words “back” and “outwardly” are interchangeable and relate to a direction in which the back or dorsal region of the wearer faces, when the wearer is standing. Similarly, the words “front”, “forwardly” and “inwardly” are also interchangeable are used in the opposite sense. Also, “upper” relates to a shoulder region, while “lower” relates to a lumbar region.

The upper portion of the dorsal member may include two upper harness engagement zones that are spaced and positioned to overlie, at least partially, respective scapula regions of the wearer, the harness engagement zones being configured for allowing the support device to be engaged with a harness. The upper harness engagement zones may each define a slot through which straps of the safety harness can be threaded to locate the support device on the safety harness.

The lower portion may include at least one lower harness engagement zone that is configured for allowing the support device to be engaged with a harness.

The, or each, lower harness engagement zone may define a slot through which a component of the harness can be threaded.

The lower portion may include two lower harness engagement zones that are spaced and positioned to overlie a lower region of a wearer's rib cage, the lower portion being bifurcated.

The dorsal and neck support members may together define a unitary construction.

The support device may have an overall vertical height or length of between about 380 mm and 450 mm.

Instead, the support device may have an overall vertical height or length of between about 330 mm and 380 mm.

An overall width of the support device at the upper portion may be between about 230 mm and 260 mm.

An overall width of the support device at the lower portion may be between about 225 mm and 255 mm.

Instead, an overall width of the support device at the lower portion may be between about 195 mm and 230 mm.

The support device may include webbing that is fast with the dorsal member and connectors that are arranged on the webbing to facilitate connection of the webbing to the safety harness.

The webbing may comprise two straps, each strap extending across the dorsal member from a lower side to an upper side, with the connectors arranged on respective ends of the straps.

The straps may overlie each other across the dorsal member.

Each connector may be a conventional loop connector so that straps of the harness can be connected to the webbing.

Various exemplary embodiments of a fall arrest harness comprise

a waist band;

a thigh support arrangement that is connected to the waist band to be positioned behind the thighs and between the buttocks and knees of a wearer, in use;

two straps, each strap being configured for operative engagement with a respective shoulder of the user and operatively connected to the waist band;

a recumbency mechanism that is operatively engaged with the waist band, the recumbency mechanism being connectable to a tether so that, in a fall arrest situation, the recumbency mechanism operates to place the wearer in at least a partially recumbent or seated position; and
a support device that comprises
a dorsal member, the dorsal member being configured for arrangement on a dorsal region of a wearer and in a position in which the dorsal member is interposed between the safety harness and the dorsal region of the wearer, the dorsal member having an upper portion, a lower portion and an intermediate portion interposed between the upper and lower portions; and
a neck support member that extends from the upper portion of the dorsal member and is configured to support a neck of the wearer when the dorsal member is arranged on the dorsal region of the wearer, wherein
the dorsal member has a profile to correspond to a generic side profile of a thoracic spine of the wearer and the neck member extends backwardly from the upper portion of the dorsal member, such that the dorsal member can distribute pressure exerted by the harness and the neck support member can cradle the neck and support the head in a tilted back condition.

The straps may be connected to a rear portion of the waist band and the dorsal member of the support device may define two upper slots and two lower slots so that the straps can be threaded through the slots to locate the support device.

The support device may include webbing that is fast with the dorsal member and connectors that are arranged on the webbing to facilitate connection of the webbing to the straps and the waist band.

The webbing may include two straps, each strap extending across the dorsal member from a lower side to an upper side. The connectors may be arranged on respective ends of the straps such that two upper connectors can connect to the straps and two lower connectors can connect to the waist band with suitable connection webbing.

The recumbency mechanism may comprise a guide that is arranged on a front of the waist band and two seat straps each being connected, at one end, to the thigh support arrangement, the guide being configured to permit movement of the seat straps relative to the waist band and opposite ends of the seat straps being connectable to a safety lanyard or the like so that, in a fall arrest situation, the seat straps can facilitate placement of the wearer in the at least partially recumbent or seated position.

The straps may be configured to extend over a pectoral and abdominal region of the wearer and may be connected to the waist band so that the straps can also facilitate placement of the wearer in the at least partially recumbent or seated position.

The straps may each be fastened to a work positioning connector which, in turn, may be connected to the waist band.

### DESCRIPTION OF THE DRAWINGS

FIG. 1 shows a three dimensional view, from the front, of one embodiment of a support device for a harness.

FIG. 2 shows a plan view of the support device of FIG. 1.

FIG. 3 shows a side view of the support device of FIG. 1.

FIG. 4 shows a rear view of another embodiment of a support device for a harness.

FIG. 5 shows a rear view of another embodiment of a support device for a harness.

FIG. 6 shows a rear view of a harness incorporating the support device of FIG. 1.

FIG. 7 shows a rear view of a harness incorporating the support device of FIG. 2 or 3.

FIG. 8 shows a front view of one embodiment of a harness.

FIG. 9 shows a front view of another embodiment of a harness.

FIG. 10 shows a detailed view of an alternative arrangement of thigh seat webbing and thigh straps.

FIG. 11 shows a front view of part of a waistband of the harness of FIG. 8 incorporating a recumbency mechanism.

FIG. 12 shows a front view of part of a waistband of the harness of FIG. 8 incorporating the recumbency mechanism with a backup device

FIG. 13 shows a detailed view of part of the recumbency mechanism of FIG. 12.

FIG. 14 shows the harness of FIG. 9, in use.

FIG. 15 shows a rear view of an embodiment of a support device for a harness.

FIG. 16 shows a rear view of an embodiment of a support device for a harness.

FIG. 17 shows a side view of the support device of FIG. 16.

FIG. 18 shows a rear view of an embodiment of a support device for a harness.

FIG. 19 shows a rear view of an embodiment of a support device for a harness.

FIG. 20 shows a rear view of a harness that incorporates the support device of FIG. 18.

### DESCRIPTION OF THE EMBODIMENTS

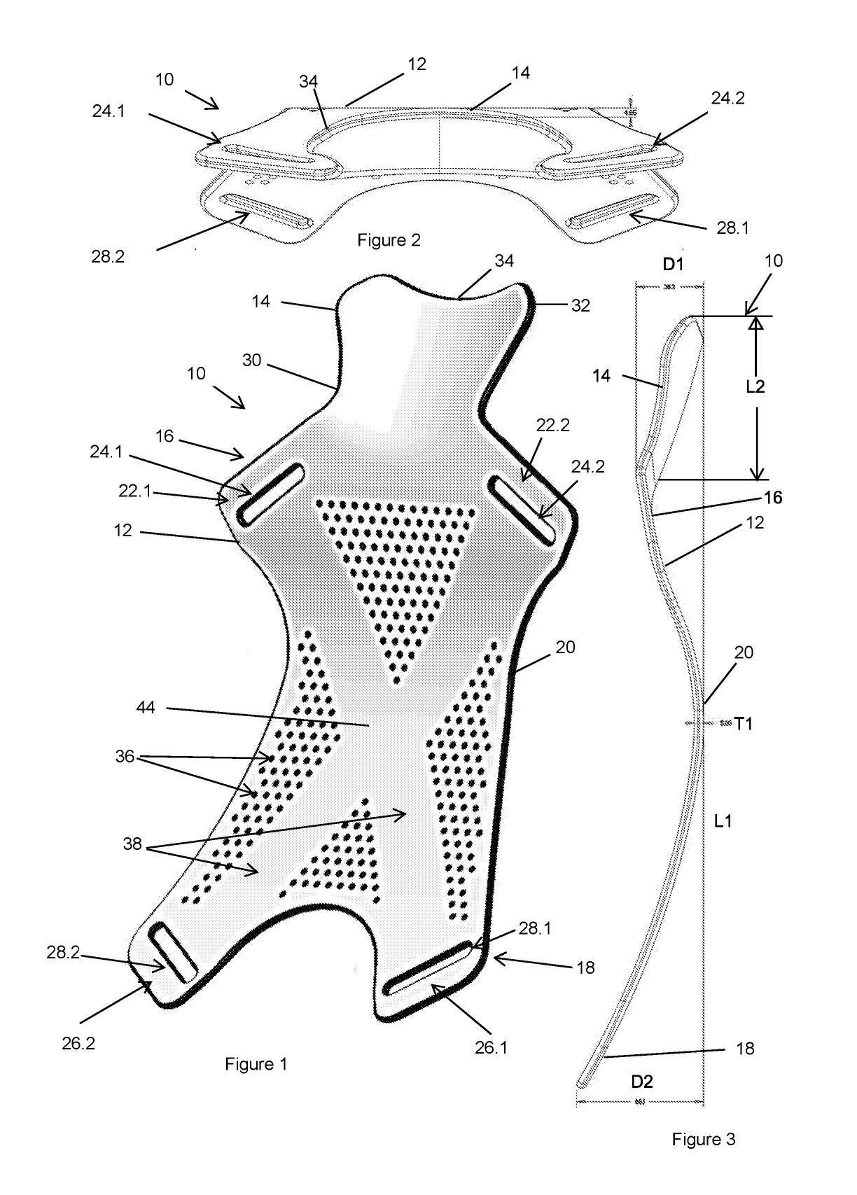

In FIGS. 1 to 3, reference numeral 10 generally indicates an embodiment of a support device for a harness. The harness can be a fall arrest harness, for example. However, it is envisaged that the support device may be useful for or used with other forms of harnesses. A harness is to be understood as some form of arrangement that is worn on the wearer's body so as to provide some form of functionality. This could include fall arrest and other safety purposes and storage of items for easy access. Such a harness usually incorporates straps and/or webbing. It can also incorporate panels and other components such as pockets, lanyards, clips, buckles for adjustment and other utility components.

In many cases, a wearer is required to wear the harness for an extended period of time. For example, in situations where outdoor work in elevated conditions is to be carried out it may be necessary for the harness to be worn for an entire work day. In such a case, it is desirable that the harness be made as comfortable as possible and also incorporate ergonomic features or accessories that can provide comfort for long-term use. In addition, it is desirable that the wearer feels safe, particularly in hazardous conditions. The support device 10 is intended to provide such functionality.

The support device 10 is suited for temporary or permanent engagement with a harness. It is also envisaged that the support device 10 can form part of a harness.

The support device 10 includes a dorsal member 12. The dorsal member 12 is configured for arrangement on a dorsal region of a wearer and for operative engagement with a safety harness. More particularly, the dorsal member 12 is dimensioned to overlie the thoracic spine of an average or generic wearer. Thus, the dorsal member has a profile that corresponds to a generic side profile of the thoracic spine of the wearer.

A neck support member 14 extends from an upper portion 16 of the dorsal member 12 and is configured to support a neck of the wearer when the dorsal member 12 is arranged on the dorsal region of the wearer. More particularly, the neck support member 14 is configured to overlie the cervical spine of the average or generic wearer. In one possible form of operation, the neck support member 14 is configured so that when a wearer is supported in at least a partially recumbent position, that is to say either angled or generally horizontal, such as might occur in a fall arrest event, the neck support member 14 is substantially in contact with a region of the wearer extending upwardly from a position slightly above and between the shoulder blades to the back of the head. As a result, the neck is cradled while the head is supported. There are a number of uses associated with such a configuration. For example, even during the extended wear, as mentioned above, the wearer can rest his or her head backwardly against the neck support member to ease discomfort in the upper shoulder and neck area. Thus, the neck support member 14 has ergonomic uses.

In another example, during a fall arrest event or any other event in which there is a danger of whiplash, even if the wearer was unconscious, the region mentioned above would remain substantially in contact with the neck support member, so reducing shock or impact at the time of fall arrest or other whiplash-incurring event.

The dorsal member 12 and neck support member 14 are in the form of a unitary construction. For example, the dorsal and neck support members 12, 14 may be moulded, cast, printed or machined. Such a unitary construction can provide an element of flexure during a fall arrest event, depending on the material selected for the fabrication of the dorsal member 12 and neck support member 14. Also, the unitary construction allows for a fabrication process in which the steps required are significantly less then what would be required for a composite product. That said, it is envisaged that the dorsal member 12 and neck support member 14 can also be in the form of a composite or assembled configuration.

As can be seen in FIG. 3, the dorsal member 12 has a profile to correspond to a generic side profile of the thoracic spine of the wearer. Thus, the dorsal member 12 curves or extends outwardly from the upper portion 16 to an intermediate portion 20 about one third to a half of a vertical length of the dorsal member 12 away from the upper portion 16 and then curves or extends inwardly to a lower portion 18 of the dorsal member 12.

The dorsal member 12 has a narrowest width at the intermediate region 20. This allows the wearer to move his or her arms about without interference from the dorsal member 12. This also helps to optimise the weight of the support device while still maintaining its functionality.

The upper portion 16 includes two upper harness engagement zones 22.1, 22.2 that are spaced and positioned to overlie respective scapula regions of the wearer. The harness engagement zones 22.1, 22.2 are configured for allowing the support device to be engaged with a harness, for example, straps of the harness.

In this embodiment, the zones 22.1, 22.2 each define slots 24.1, 24.2 through which straps of a fall arrest harness can be threaded.

The lower portion 18 includes two lower harness engagement zones 26.1, 26.2 that are spaced and positioned to overlie a lower region of the ribcage. The lower portion 18 is bifurcated so that the zones 26 are separated by an arcuate or curved recess. In this embodiment, the zones 26.1, 26.2 each define slots 28.1, 28.2, respectively, through which the straps can be threaded.

The support device 10 can have a range of dimensions. However, it will be appreciated that the support device 10 may have dimensions that would suit the average or generic person that might be performing activities in a field in which the harness may be required. It will be understood that this might not include persons of excessively short stature, such as children. It might also not include persons of excessively large stature, such as obese persons who might not normally be found in such fields. In some cases, the support device 10 can have dimensions that would suit persons having the characteristics mentioned above. However, for the purposes of understanding the form of the device 10, the “average person” referred to above is the “wearer” referred to in the specification, including the claims, of this document. Furthermore, it is not necessarily the case that the support device 10 might not find application, within the dimensional range referred to in the specification and claims, for activities carried out by persons who would not be considered as falling within the definition of the “average person” referred to above. It is also envisaged that the support device 10 may be provided with dimensions that suit specific classes of persons, such as children or outsized persons.

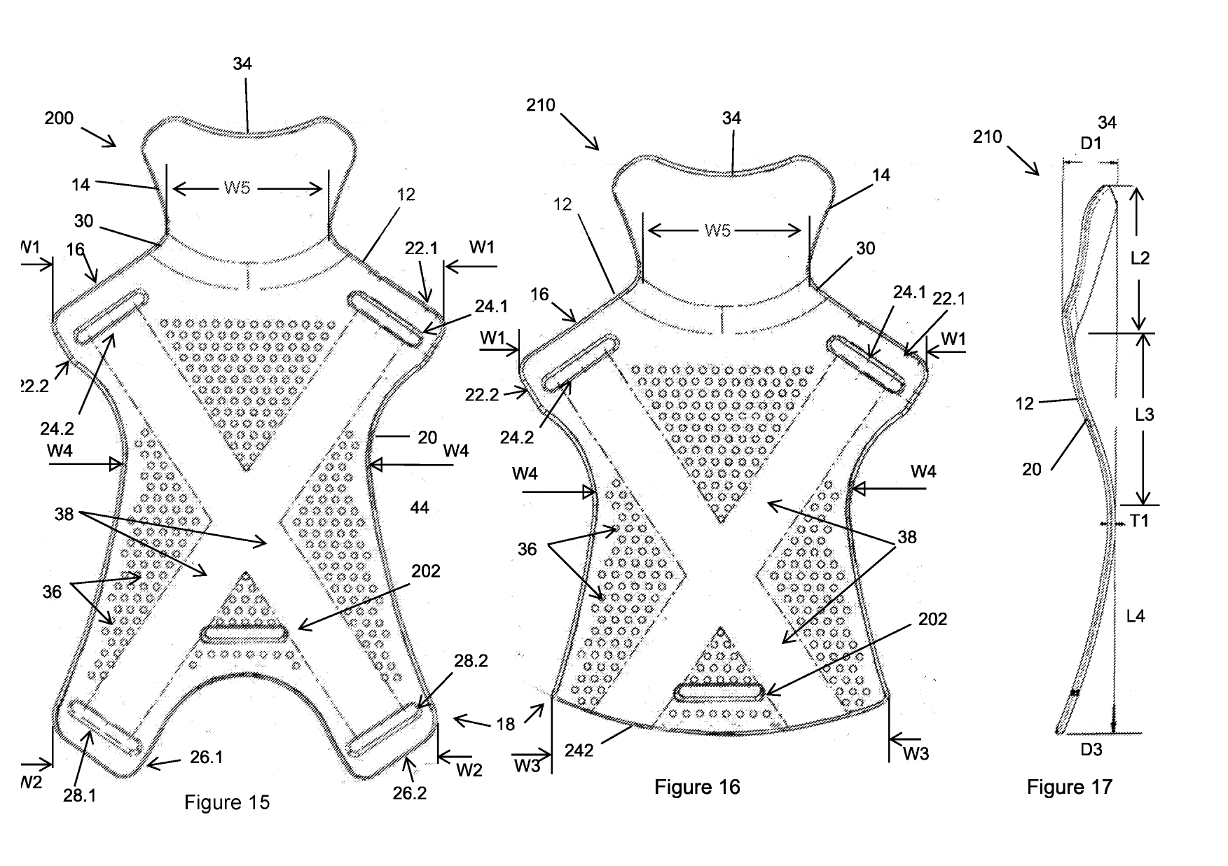

For example, an overall vertical height or length (L1) of the device 10 can be between about 380 mm and 450 mm, for example, between about 410 mm and 420 mm, such as 414 mm. An overall width (W1—FIG. 15) of the device 10 at the upper harness engagement zones 22 can be between about 230 mm and 260 mm, for example, between about 240 mm and 250 mm, such as 245 mm. An overall width (W2—FIG. 15) of the device 10 at the lower harness engagement zones 26 can be between about 225 mm and 255 mm, for example, between about 230 mm and 250 mm, such as 240 mm. An overall width (W4—FIGS. 15 and 16) at the intermediate zone can be between about 140 mm and 170 mm, such as 152 mm.

The dorsal member extends outwardly and downwardly to a vertical extent (L3) of between about 100 mm and 150 mm.

The neck support member 14 extends backwardly from the upper portion 16 of the dorsal member 12. The neck support member 14 extends backwardly (D1) between about 30 mm and 40 mm, such as 36 mm. Thus, when the head and neck are supported by the support member 14, the head is tilted slightly backwardly to ensure that the wearer's breathing passages remain open. In this position, the neck support member 14 serves to cradle the neck of the wearer as has been described above.

The neck support member 14 has a vertical height (L2) of between about 70 mm and 130 mm.

It will be appreciated that the neck support member 14 serves to support the head and neck in a fall arrest event or any other event in which whiplash or hyperextension is a factor. This can serve to reduce or neutralise whiplash or hyperextension of the neck as result of the fall or other event. Conventional safety harnesses are not provided with some form of neck support. As a result, a fall arrest event where the wearer is supported in a partially reclined or recumbent position can result in severe injury to the spinal region of the neck and even the upper back. A safety harness provided with or incorporating the support device 10 can alleviate or ameliorate this problem.

Furthermore, the backward tilting of the head as a result of the configuration of the dorsal member 12 and the neck support member 14 can serve to keep the air passages of the wearer open in the event that the wearer happens to lose consciousness as a result of the fall. With loss of consciousness and without the support device 10, the wearer's head can over-extend backwardly resulting in blockage of the airways and, as a result, possibly death.

From the front, the neck support member 14 has a narrowed collar 30. The support member 14 tapers outwardly from the collar 30 to a cranial portion 32. The cranial portion 32 has a downwardly curved upper edge 34 to accommodate the back of the wearer's head. Opposite sides of the cranial portion 32 are rounded. The narrowed collar 30 has an overall width (W5) (FIGS. 15 and 16) of between about 95 mm and 110 mm, such as 102 mm.

The neck support member 14 is also curved in a horizontal plane with a horizontally outermost point in general vertical alignment with a horizontally outermost point of the dorsal member 12.

The curvature of the neck support member 14, in a transverse plane, serves to retain the head against excessive movement from side to side subsequent to a fall arrest or other whiplash-incurring event. In addition to hyperextension, such excessive side to side movement could also cause injury in the absence of the curvature in the transverse plane. That curvature also serves to retain the head in a comfortable forward facing position so that the wearer can rest his or her head without excessive swivelling or tilting.

The neck support member 14 is dimensioned so as not to interfere with normal movement of the head while the wearer works. In other words, the backwardly angled orientation and the height or length of the neck support member 14 are appropriately selected so as to allow normal movement of the head without interference.

An overall depth (D2) of the support device 10 is between about 60 mm and 80 mm, for example, 68 mm.

The support device 10 has a consistent thickness (T1) of between about 3 mm and 7 mm.

The slots 24, 28 can be in the form of diagonally opposed pairs, one pair being 24.1 and 28.1 and the other pair being 24.2 and 28.2. The slots 24.1, 28.1 are oriented to be generally orthogonal to one of the straps. Likewise, the slots 24.2, 28.2 are oriented to be generally orthogonal to another of the straps. Thus, the straps can cross and overlie each other. In such a position, the straps can serve to enhance the structural integrity of the support device 10.

Each slot 24, 28 has a length and width to accommodate conventional straps or webbing that would be used in a conventional fall arrest harness. Alternatively, the slots 24, 28 have a length and width to accommodate straps or webbing that might be used in a customised harness suited for the support device 10.

The dorsal member 12 is ventilated for comfort. Ventilation of the dorsal member 12 is achieved by a plurality of openings 36 defined in the dorsal member 12. As can be seen, the openings 36 are arrayed to define paths 38 for the straps or webbing of the fall arrest harness. The openings 36 also serve to reduce the amount of material used for the fabrication of the support device 10 while maintaining the integrity of the device 10.

In this example, the support device 10 is fabricated from a plastics material. For example, the support device 10 can be fabricated from polypropylene or similar material. However, the inventor envisages that the support device 10 can be fabricated from various materials that may be suited for purpose.

The support device 10 provides a mechanism whereby the pressure exerted by the straps of the fall arrest harness are distributed by the dorsal member 12. Thus, the dorsal area of the user or wearer can be protected from potential damage by the straps in a fall arrest situation. Furthermore, the neck support member 14 is configured to prevent whiplash or neck hyperextension in such a situation.

In addition, the support device 10 can provide a level of comfort during normal working conditions. For example, a wearer can simply lean back and relax without the straps exerting pressure directly on the wearer's body which could cause discomfort over time. Also, the wearer can relax his or her head with the support member 14 providing head and neck support, while the neck is cradled.

Thus, the material from which the support device 10 is fabricated is selected to provide sufficient rigidity to perform the functions described above. It follows that, in some cases, the support device 10 can be fabricated from a material that is generally inflexible. In other cases, the support device 10 can be fabricated from a material that has a predetermined extent of give or flexibility. Such give or flexibility can permit the support device 10 to absorb a certain amount of shock in the event of a fall arrest situation. Furthermore, the material can be selected so that the neck support member 14 can flex to a certain degree with respect to the dorsal member 12. This can also serve to absorb impact which would otherwise be transmitted to the wearer's head and neck.

In addition to provision for straps, the slots 24, 28 can also be used to connect a utility pack to a safety harness. For example, the slots 24, 28 can be used to connect a utility pack such as a hydration pack to the safety harness. Alternatively, the utility pack can be connected or mounted on the upper harness engagement zones 22.

As can be seen from the drawings, a side profile (FIG. 3) of the support device 10 generally matches a spinal profile of a generic or average wearer. As such, the support device 10 facilitates healthy spinal ergonomics both during a fall arrest or other whiplash-incurring event and during normal day-to-day work.

Furthermore, this allows substantially the whole front surface 44 of the dorsal member 12 to remain generally in contact with the wearer's dorsal region. Thus, in a fall arrest situation, the pressure exerted on the dorsal region is substantially immediately dispersed. Also, in general use, this general contact provides a level of comfort to the wearer. It follows that the dorsal member 12 has ergonomic as well as safety applications.

Furthermore, the support device 10 provides a suitable platform for the bracing of a wearer's head in order to minimise or prevent exacerbation of any existing head, neck or spinal injury. For example, the wearer's head could be bandaged to the neck support member 14.

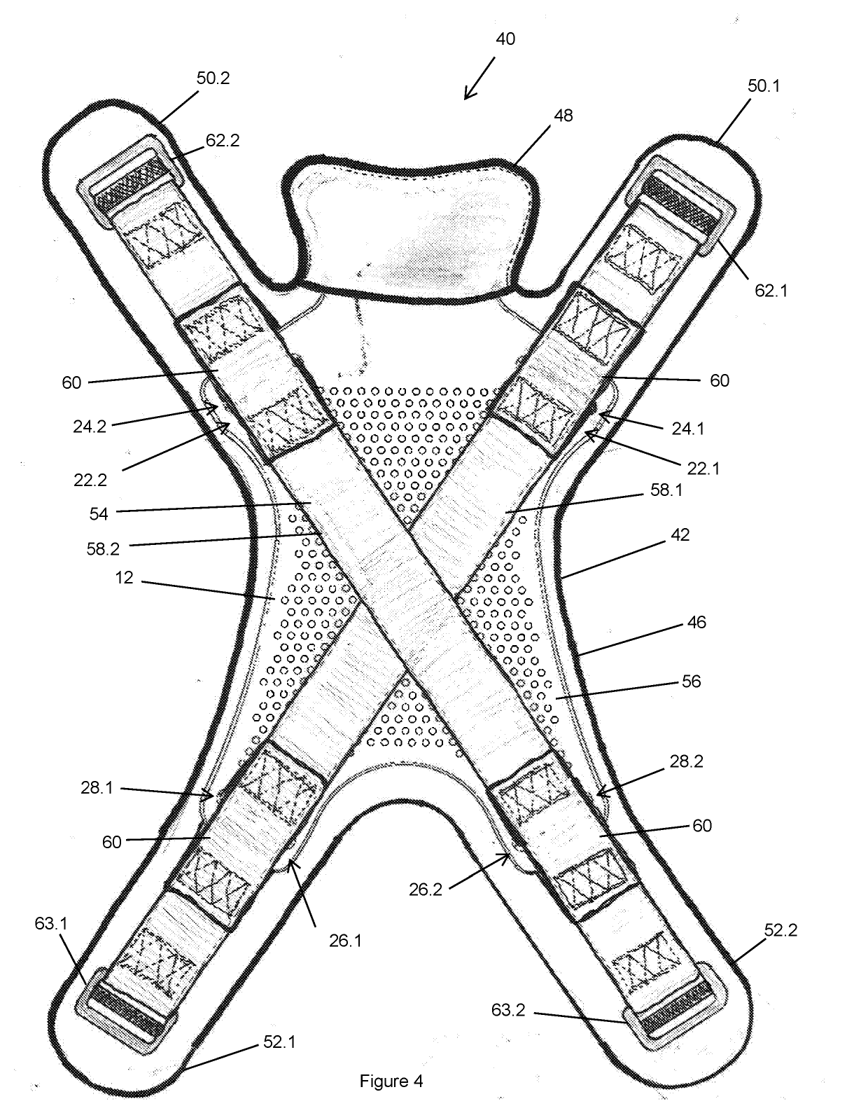

In FIG. 4, reference numeral 40 generally indicates an embodiment of a support device. With reference to the preceding drawings, like reference numerals refer to like parts, unless otherwise specified. The use of common reference numerals is not intended to limit the scope of the appended claims and is for the purpose of convenience only. Furthermore, components or characteristics of the support device 10 are interchangeable with components or characteristics of the support device 40, if possible and/or practicable.

The support device 40 includes a padding or cushioning member 42. The member 42 is fastened to an inner or front surface 44 (FIGS. 1 to 3) of the dorsal member 12.

The member 42 has a dorsal portion 46 that is larger than the dorsal member 12 so that it extends past edges of the dorsal member 12.

A pocket 48 is arranged on the dorsal portion 46. The pocket 48 is configured so that the support member 14 can be received in the pocket 48. This can provide cushioning for the neck and head region of the wearer. It can also help to facilitate a reduction in whiplash during a fall arrest event.

The member 42 has two pairs of upper and lower diagonally opposite legs or arms 50.1, 50.2 and 52.1, 52.2. The arms 50.1, 50.2 are positioned to extend from the upper engagement zones 22.1, 22.2, respectively. The arms 52.1, 52.2 are positioned to extend from the lower engagement zones 26.1, 26.2, respectively.

The padding member 42 and the pocket 48 are of a suitable padding material. An example of such a material is an expanded plastics material, woven or non-woven textile material, or the like.

The support device 40 includes webbing 54 that is fastened to a back surface 56 of the dorsal member 12. This attachment can take different forms. For example, the attachment can be by way of press studs, adhesive, Velcro™ or any other form of suitable fastening, permanent or temporary.

The webbing 54 includes two straps 58.1, 58.2 that are fastened to the dorsal member 12 to overlie the paths 38. In this example, the straps 58 are received through the slots 24, 28. Fastening strips 60 are stitched to the straps 58, at each engagement zone 22, 26 and on each side of the associated slot 24, 28 to secure the straps to the dorsal member 12.

The straps 58 can be of webbing material of the type that is used in safety harnesses. The strips 60 can also be of such a webbing material.

Loop connectors 62.1, 62.2 are fastened to respective upper ends of the straps 58. Loop connectors 63.1, 63.2 are fastened to respective lower ends of the straps 58. The loop connectors 62 allow straps of a fall arrest harness to be connected to the straps 58 so that the fall arrest harness can be connected to the support device 40. Thus, the loop connectors 62, 63 can be conventional loop connectors.

The support device 40 is suited for use with a fall arrest harness that does not have straps that are sufficiently long to extend across the dorsal member 12.

The inventor envisages that the straps 58 need not cross over, as shown in the drawings. Instead, the straps could extend parallel to each other between appropriately oriented slots or by means of some other fastening arrangement.

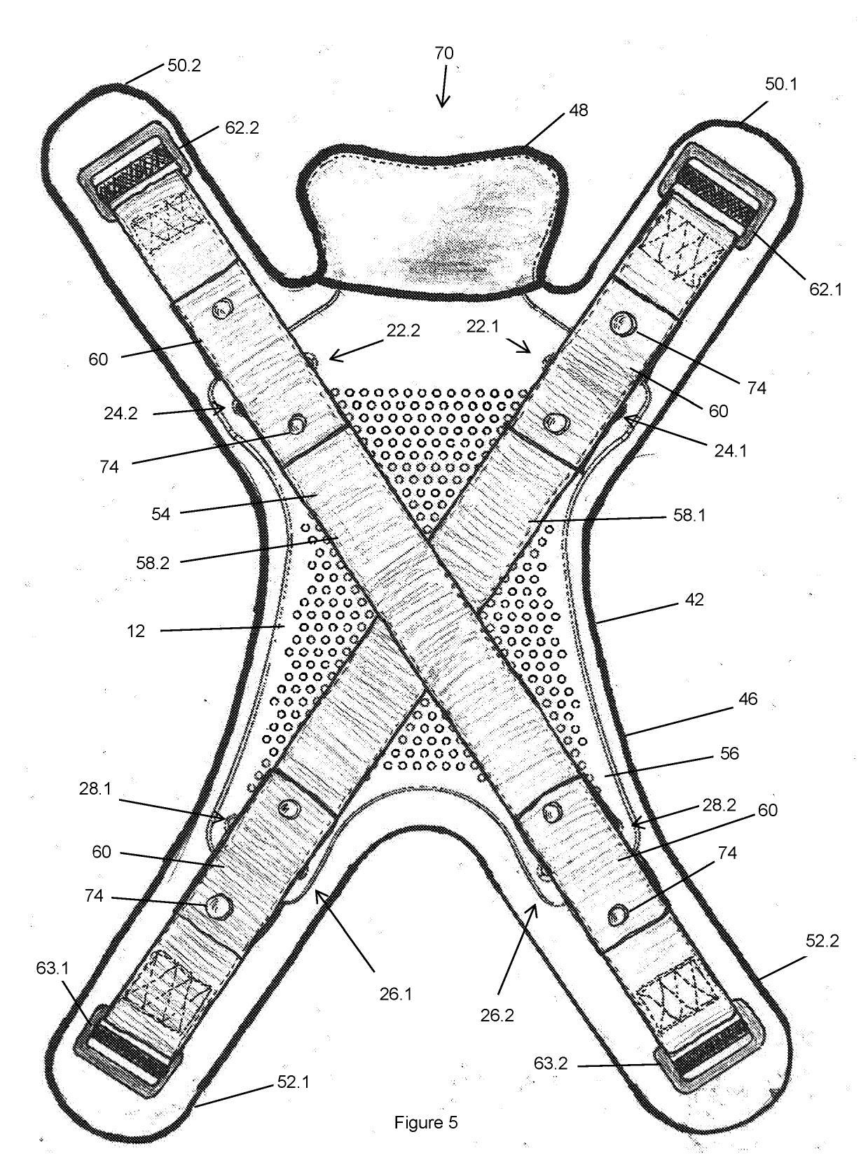

In FIG. 5, reference numeral 70 generally indicates an embodiment of a support device for a fall arrest harness. With reference to the preceding drawings, like reference numerals refer to like parts, unless otherwise specified. The use of common reference numerals is not intended to limit the scope of the appended claims and is for the purpose of convenience only. Furthermore, it is to be understood that components from previous embodiments and this embodiment can be interchanged, where practical, to provide further embodiments of a support device.

In this example, connectors, such as stud connectors 74 are arranged on the strips 60 and the straps 58 so that the strips 60 can be clipped to, or unclipped from, the straps 58. The connectors 74 can also be configured to attach the strips 60 to the straps 58 in a permanent manner.

The inventor envisages that a large number of different types of connection or fastening systems can be used to fasten the strips 60 to the straps 58. These could include hook-and-eye fastening arrangements, such as Velcro™, adhesive or various hook attachments.

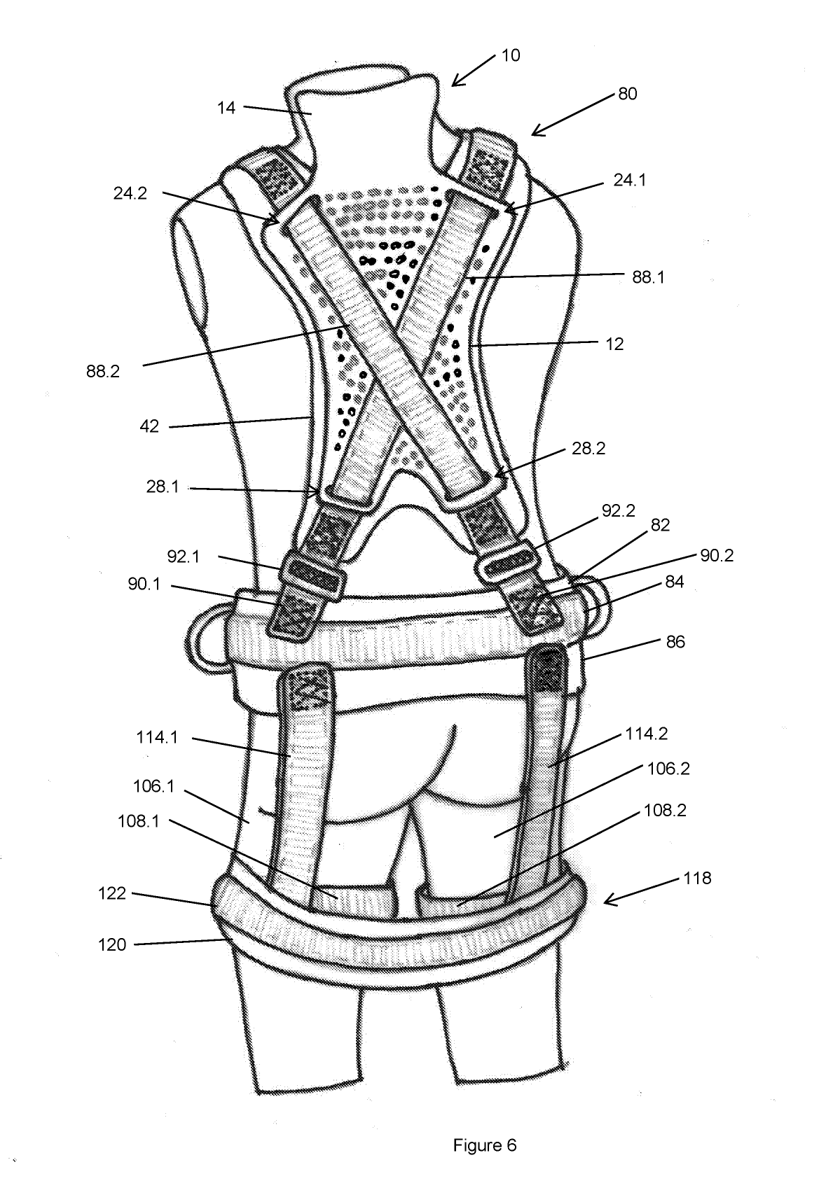

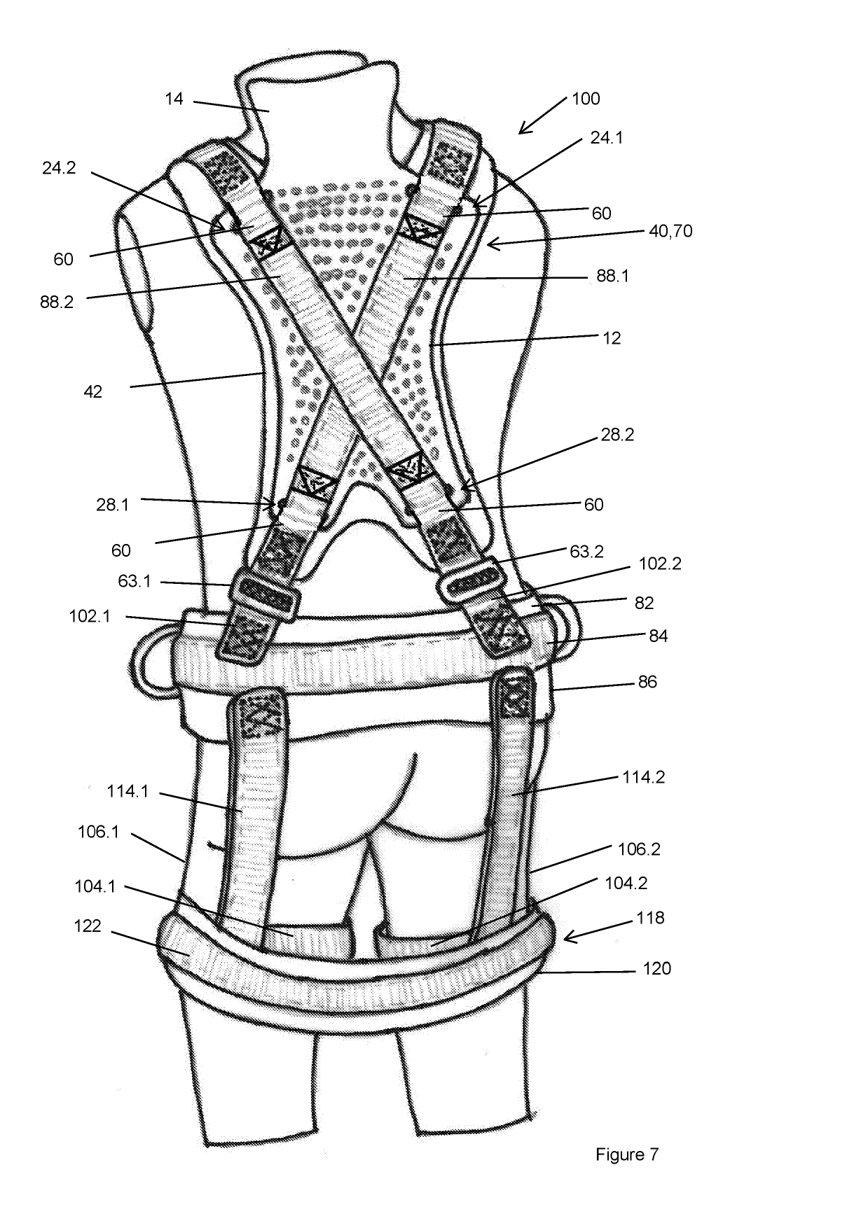

In FIG. 6, reference numeral 80 generally indicates an embodiment of a fall arrest harness using the support device 10 (FIG. 6). In FIG. 7, reference numeral 100 generally indicates an embodiment of a fall arrest harness using either of the support devices 40, 70. With reference to the preceding drawings, like reference numerals refer to like parts, unless otherwise specified. The use of common reference numerals is not intended to limit the scope of the appended claims and is for the purpose of convenience only. Furthermore, it is to be understood that components from previous embodiments and these embodiments can be interchanged, where practical, to provide further embodiments of a fall arrest harness.

The harness 80, 100 includes a waist band 82. The waist band 82 includes belt webbing in the form of a belt 84 fastened to belt padding 86.

The harness 80, 100 has two straps 88.1, 88.2 configured for operative engagement with the wearer's shoulders. In FIG. 6, the straps 88.1 pass through the slots 24.1, 28.1 and 24.2, 28.2, respectively, and overlie the paths 38, in the manner described above.

In the harness 80, a pair of tags 90.1, 90.2 is stitched to the belt webbing 84. Loop connectors 92.1, 92.2 are fastened to respective tags 90.1, 90.2. Ends of the straps 88.1, 88.2 are fastened to respective loop connectors 92.1, 92.2 thereby securing the support device 10 to the harness 80 in an adjustable manner.

In this example, the cushioning member 42 is arranged on the inner surface 44 of the dorsal member 12.

In the harness 100, the straps 88.1, 88.2 are shorter and are connected to the loops 62.1, 62.2 (FIG. 5), respectively.

A pair of tags 102.1, 102.2 are stitched to the belt webbing 84. The tag 102.1 is connected to the connector 63.1, and the tag 102.2 is connected to the connector 63.2.

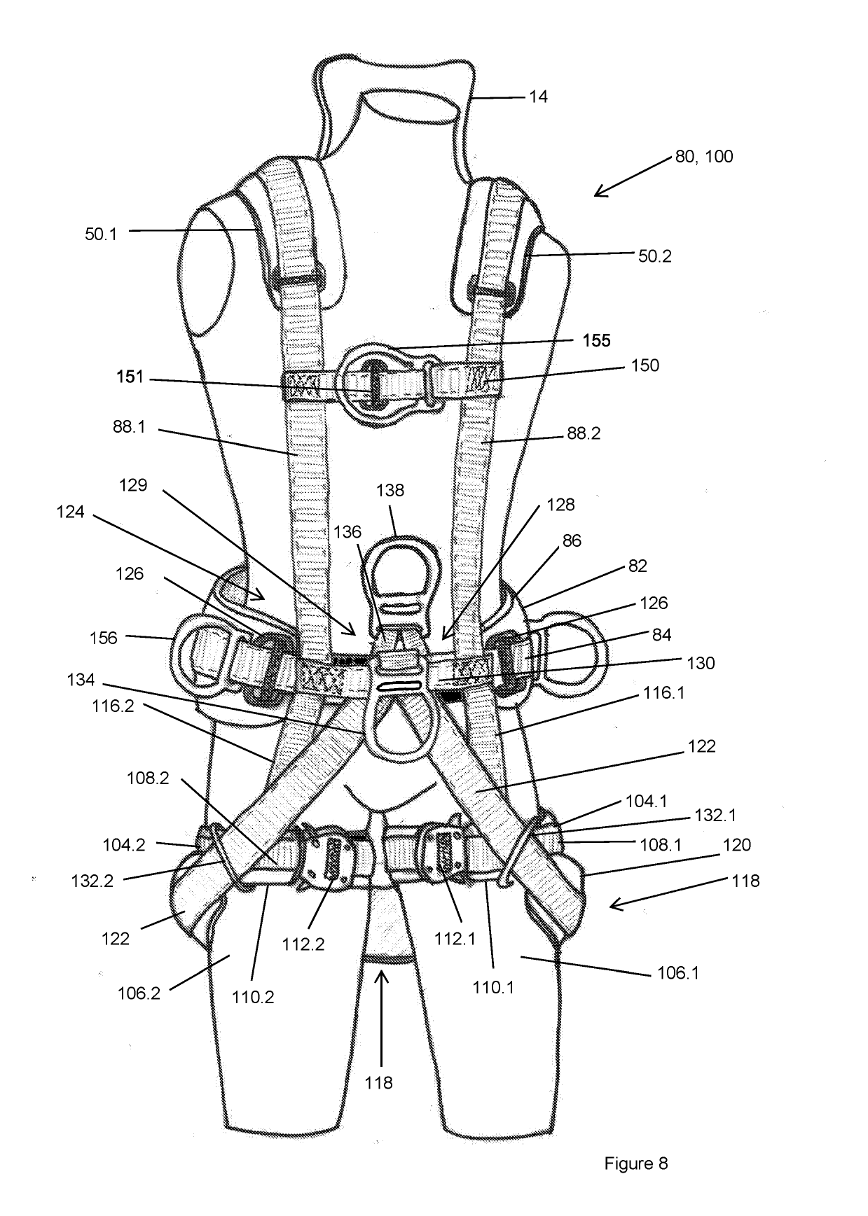

FIG. 8 shows a front view of either of the harnesses 80, 100.

The harness 80, 100 includes a pair of thigh straps 104.1, 104.2 that can be fastened about respective thighs 106.1, 106.2 of the wearer. The thigh straps 104.1, 104.2 include thigh strap webbing 108.1, 108.2 arranged on padding 110.1, 110.2. Adjustable buckles 112.1, 112.2 are arranged on the webbing 108.1, 108.2 to adjust the tightness of the thigh straps 104.1, 104.2.

Connecting straps 114.1, 114.2 interconnect the straps 104.1, 104.2 and the belt webbing 84 behind the thighs 106, as can be seen in FIG. 6 or 7. Connecting straps 116.1, 116.2 interconnect the straps 104.1, 104.2 and the belt webbing 84 in front of the thighs 106.

The harness 80, 100 includes a thigh support arrangement 118 that is configured to extend across the thighs 106 between the knees and buttocks of the wearer and at least partially about outer sides of the thighs 106.

The thigh support arrangement 118 includes thigh seat padding 120 and thigh seat webbing 122 that overlies and extends past the padding 120.

The belt webbing 84 is configured to extend about a waist portion 124 of the wearer. The belt padding 86 extends partially about the waist portion 124 to define a frontal gap 128.

Adjustment buckles 126 are arranged on the belt webbing 84 so that a tightness and fit of the waist band 82 can be adjusted.

Guide loops 132.1, 132.2 are arranged on the thigh straps 104.1, 104.2, respectively. The webbing 122 threads through the loops 132.1, 132.2.

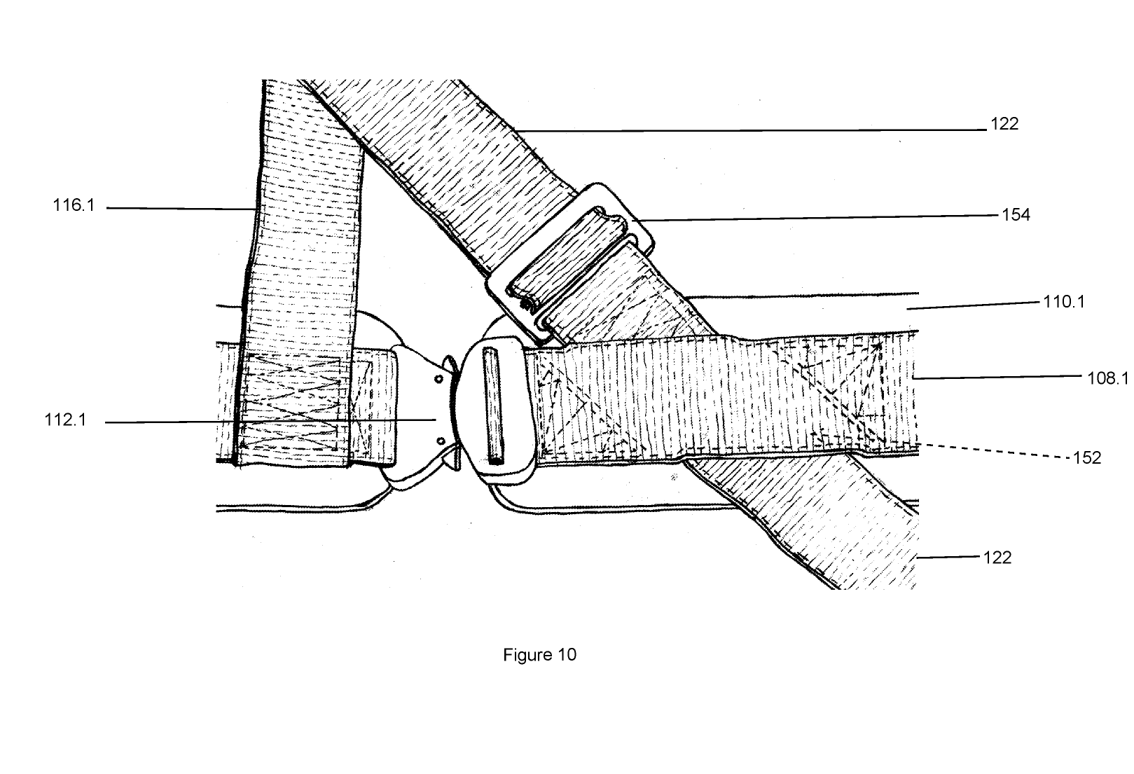

Instead of the guide loops 132.1, 132.2, the thigh strap webbing 108 can be stitched to the padding 110 to define an angled passageway 152 to accommodate the thigh seat webbing 122. Detail of this alternative arrangement is shown in FIG. 10. With reference to the preceding drawings, like reference numerals refer to like parts, unless otherwise specified. The use of common reference numerals is not intended to limit the scope of the appended claims and is for the purpose of convenience only.

An adjustment buckle 154 is arranged in the thigh seat webbing 122 so that a wearer can adjust the length of the webbing 122.

The harness 80, 100 includes a recumbency mechanism 129. The recumbency mechanism 129 is operatively engaged with the waist band 82. The recumbency mechanism 129 is connectable to a tether so that, in a fall arrest situation, the recumbency mechanism operates to place the wearer in at least a partially recumbent or seated position.

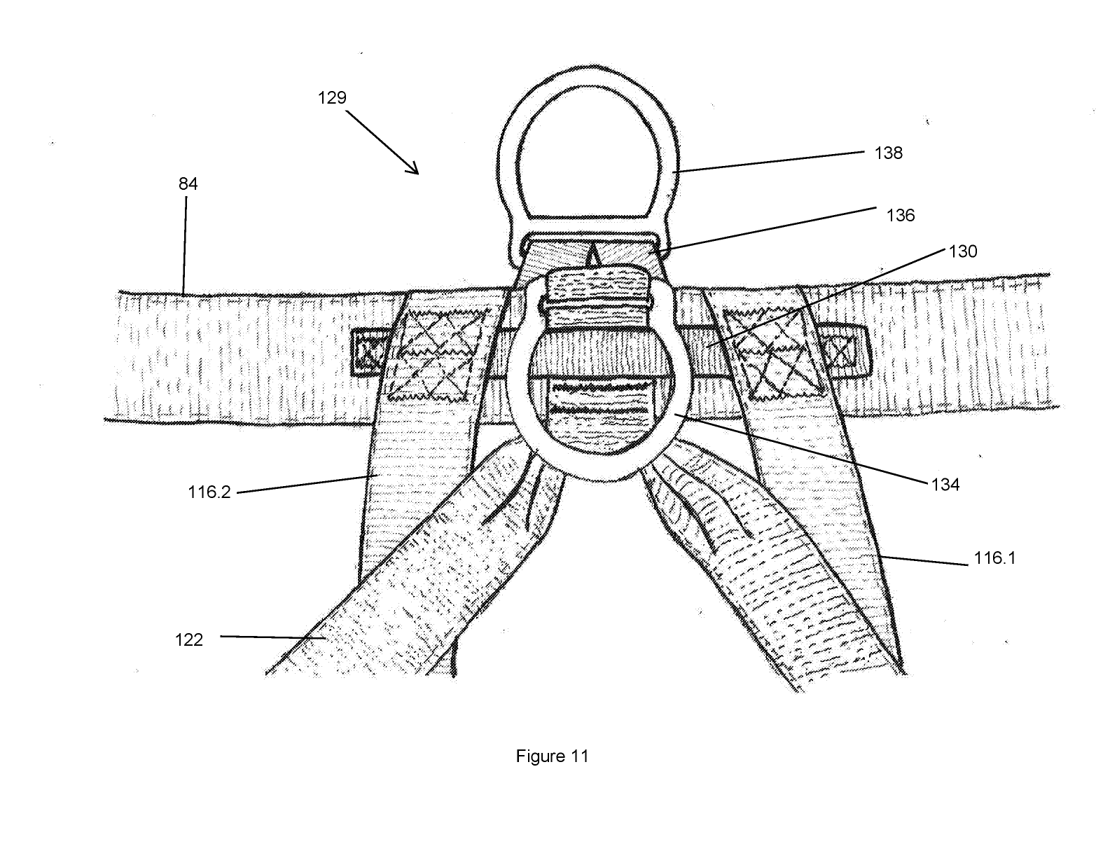

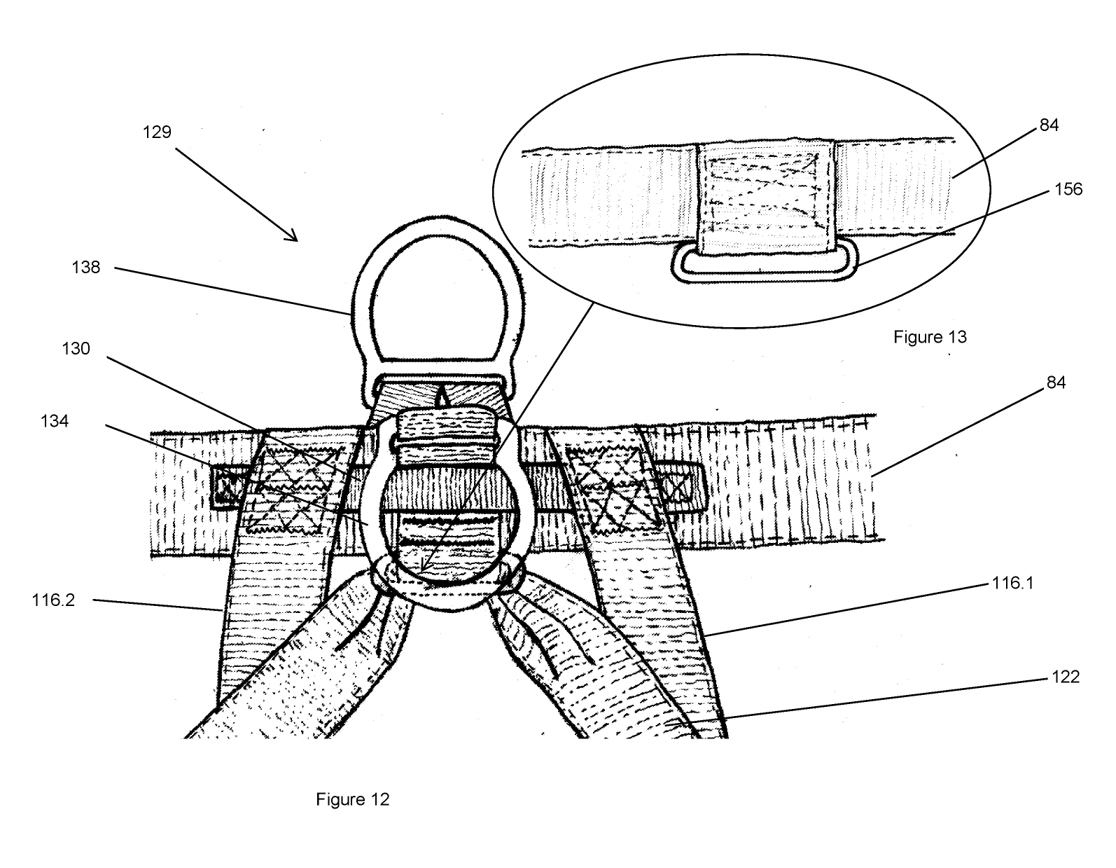

Detail of the recumbency mechanism 129 is shown in FIGS. 11 and 12.

The mechanism 129 includes a guide strap 130 that is fastened to the belt webbing 84 at its ends. Ends of the webbing 122 are fastened together and threaded between the guide strap 130 and the belt webbing 84. A tethering device, such as a D-ring 134 is connected to the webbing 122. Thus, in a fall arrest situation, the webbing 122 is at least partially drawn between the guide strap 130 and the belt webbing 84. At the same time, the webbing 122 slides with respect to the guide loops 132.1, 132.2, so drawing the thighs 106 upwardly while the wearer is supported at the waist portion 124.

The guide strap 130 can be sewn or stitched over or under the respective connecting straps 116. In this example, the guide strap 130 is sewn beneath the respective connecting straps 116.

The straps 88.1, 88.2 of the harness 80, 100 extend over the wearer's shoulders and down to the belt webbing 84 and are stitched to the belt webbing 84. Thus, as the thigh strap webbing 108.1, 108.2 acts to draw the thighs 106 upwardly, the straps 88 serve to support the wearer in at least a partially recumbent or seated position. More particularly, in the fall arrest situation, the belt webbing 84 is drawn upwardly away from the abdominal region of the wearer. This serves to set up tension in the straps 88 so that the wearer can be supported in the partially recumbent or seated position.

A lanyard connector in the form of a D-ring 138 is fastened to the belt webbing 84 with suitable connecting straps 136. The D-ring 138 is used for a work positioning lanyard. However, in the event that such a lanyard or rope is not used, the safety tether or lanyard is to be connected to both the D-rings 134, 138.

The harness 80, 100 includes a chest strap 150 that interconnects the straps 88 across a thoracic region of the wearer. An adjustment buckle 151 is arranged on the chest strap 150 to allow the chest strap 150 to be adjusted or released.

A further lanyard or rope connector, for example, in the form of a D-ring 155, is connected to the chest strap 150.

Auxiliary connectors in the form of D-rings 156 are connected to the belt webbing 84.

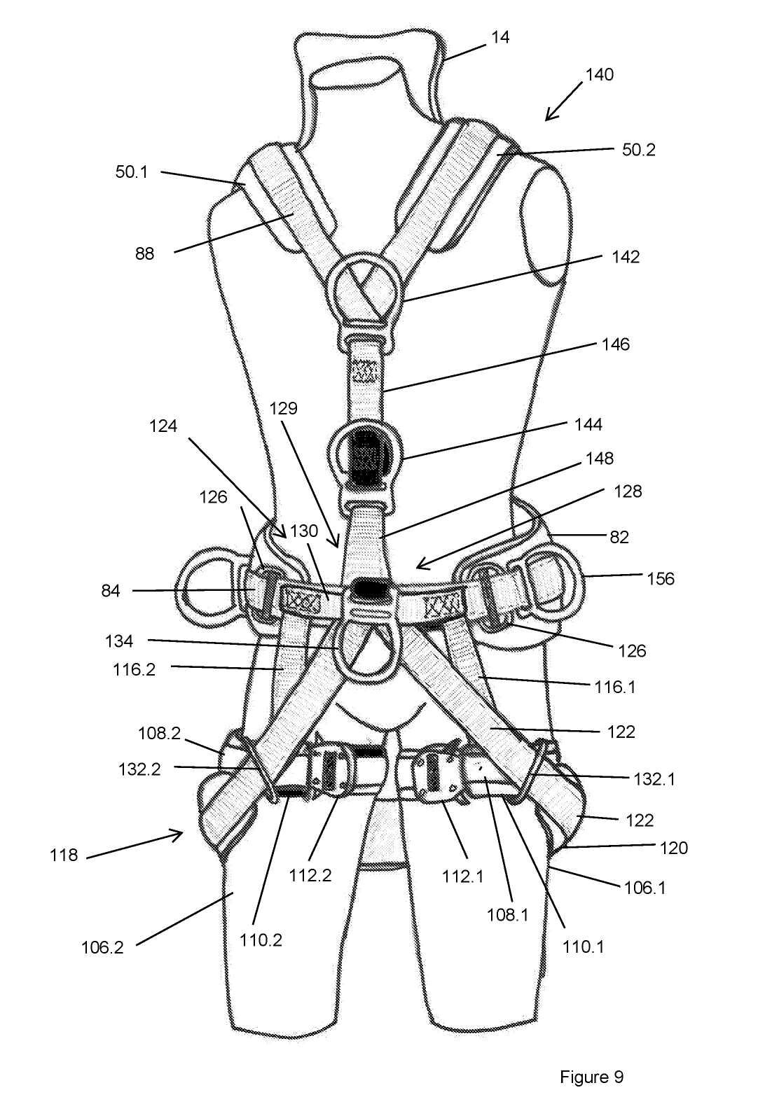

In FIG. 9, reference numeral 140 generally indicates an embodiment of a fall arrest harness. With reference to the other drawings, like reference numerals refer to like parts, unless otherwise specified. The use of common reference numerals is not intended to limit the scope of the appended claims and is for the purpose of convenience only. Furthermore, it is to be understood that components from previous embodiments and these embodiments can be interchanged, where practical, to provide further embodiments of a fall arrest harness.

The shoulder straps 88.1, 88.2 of the harness 140 are defined by a single strap 88 that extends over the wearer's shoulders and engages a work positioning connector in the form of a D-ring 142. In turn, the D-ring 142 is connected to a further work positioning connector in the form of a further D-ring 144 with a suitable strap 146. In turn, the D-ring 144 is connected to the belt webbing 84. Again, this connection is by means of a suitable strap 148.

The D-rings 142, 144 allow connection to a work positioning lanyard or rope in two positions. For example, the shoulder straps 88 and the straps 146 are configured so that one point of connection is sternal and the other is abdominal.

In a fall arrest situation, resultant movement of the belt webbing 84 can set up tension in the straps 146, 148 so that the wearer can be supported in at least a partially recumbent or seated position.

In FIGS. 12 and 13, there is shown a backup device that includes a guide loop 156 stitched to the belt webbing 84, below the guide strap 130. With reference to the preceding drawings, like reference numerals refer to like parts, unless otherwise specified. The use of common reference numerals is not intended to limit the scope of the appended claims and is for the purpose of convenience only. Furthermore, it is to be understood that components from previous embodiments and these embodiments can be interchanged, where practical, to provide further embodiments.

The webbing 122 passes through the guide loop 156 and between the guide strap 130 and the belt webbing 84. The guide loop 156 is dimensioned so that the D-ring 138 is unable to pass through the guide loop 156. The purpose of this is to serve as a backup in case the guide strip 130 fails. Should that occur, the D ring 138 is caught by the loop 156, ensuring retention of the wearer in the at least partially recumbent or seated position.

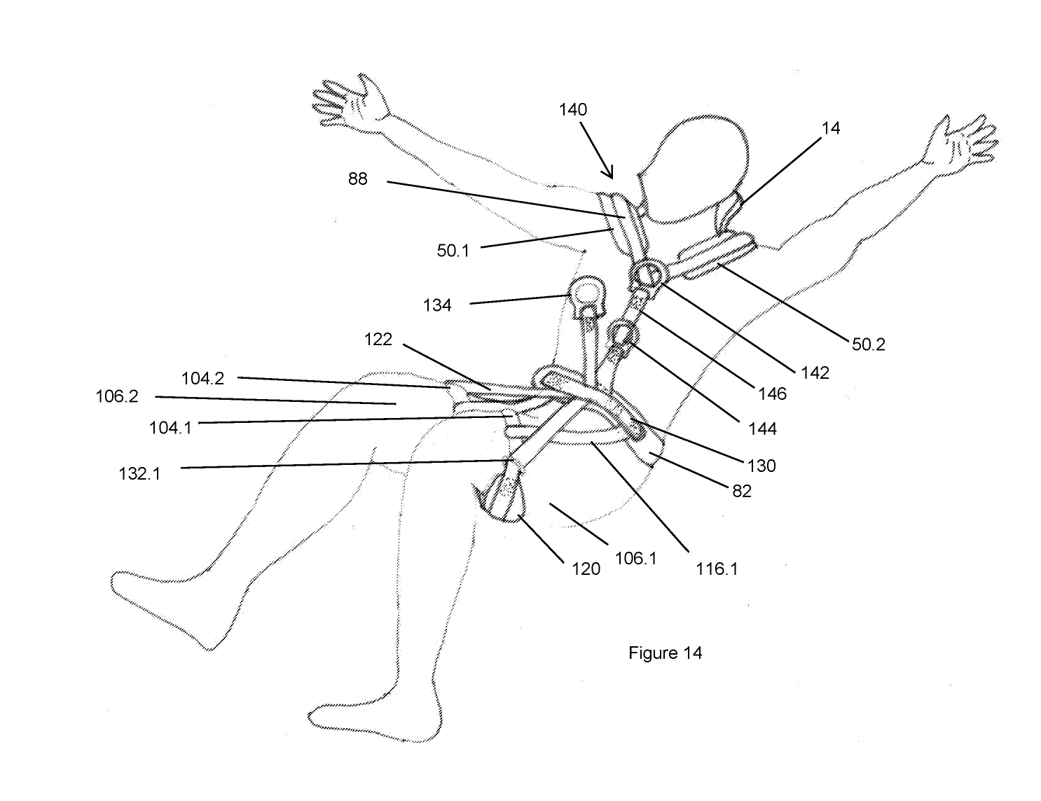

Operation of the harness 140 is shown in FIG. 14.

As can be seen in FIG. 14, the thigh seat webbing 122 is drawn partially between the guide strip 130 and the belt webbing 84. The webbing 122 thus serves to support the wearer's thighs 106.1, 106.2 generally horizontally. At the same time, a resultant tension is set up in the straps 88 via the connecting straps 146, 148. Thus, the wearer is supported in a partially recumbent or seated position.

In FIG. 15, reference numeral 200 generally indicates an exemplary embodiment of a support device for a fall arrest harness. With reference to the preceding drawings, like reference numerals refer to like parts, unless otherwise specified. The use of common reference numerals is not intended to limit the scope of the appended claims and is for the purpose of convenience only. Furthermore, it is to be understood that components from previous embodiments and this embodiment can be interchanged, where practical, to provide further embodiments of a support device.

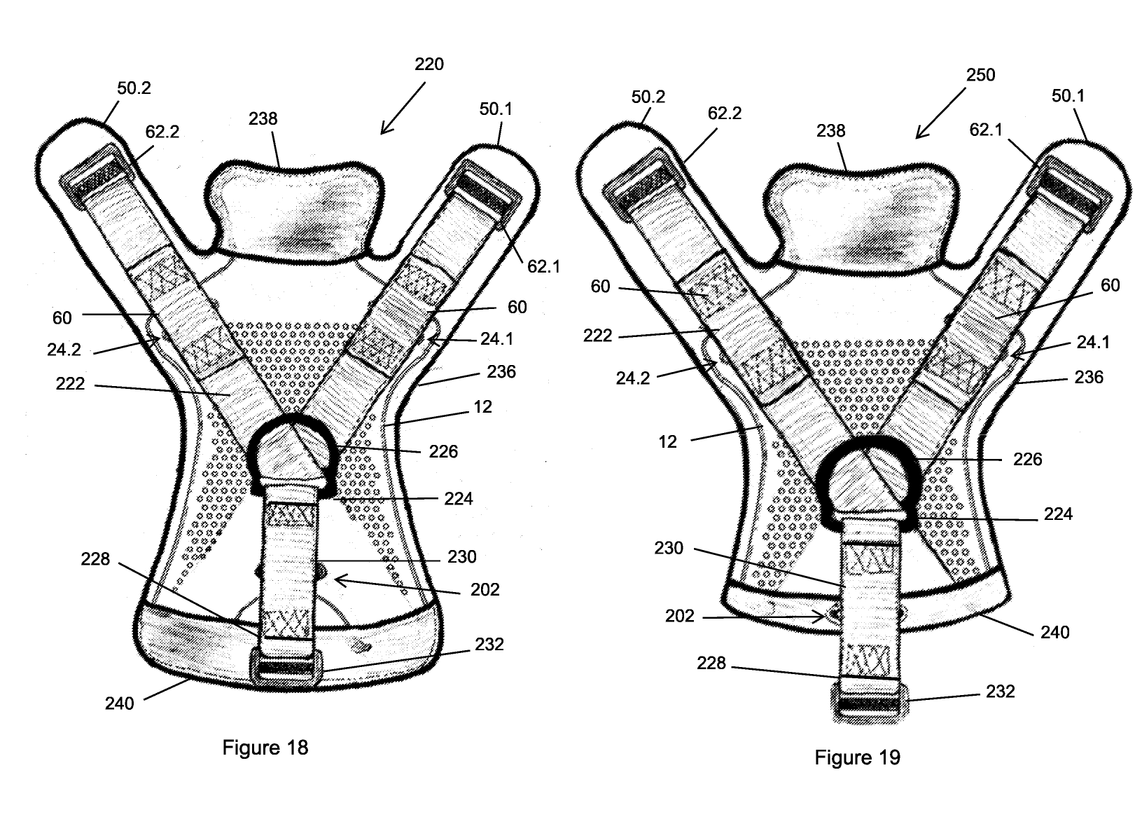

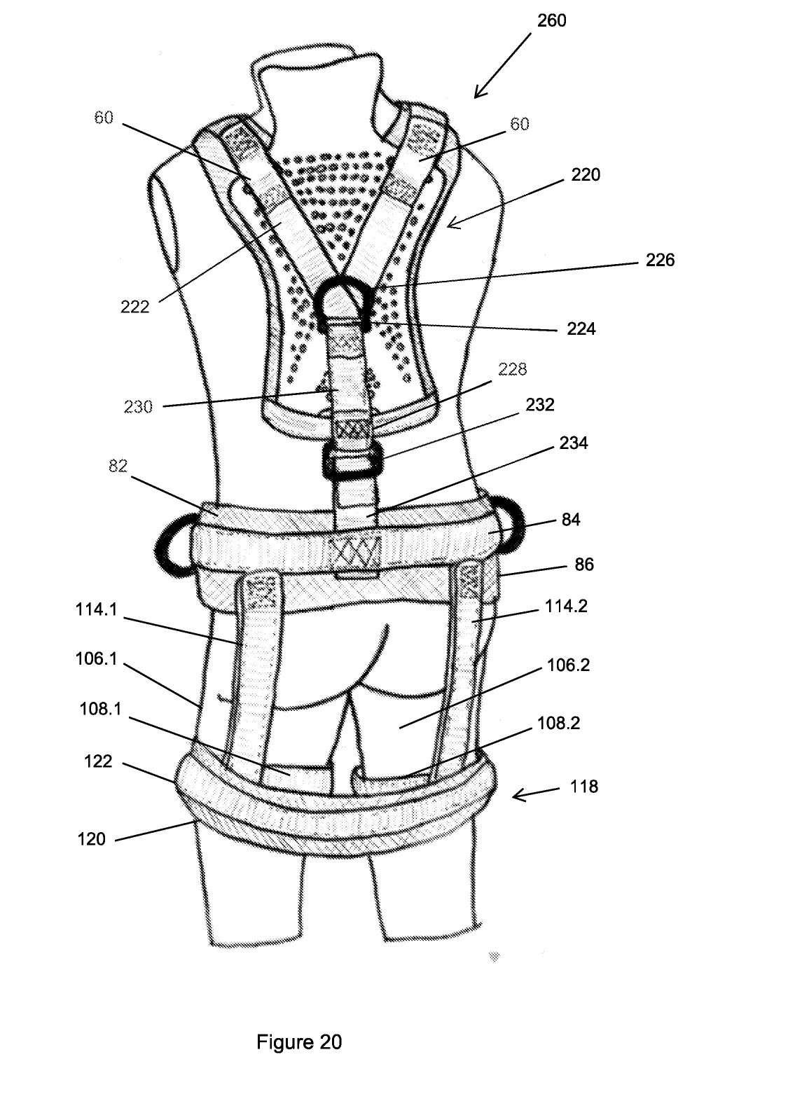

The support device 200 includes an additional, generally transversely oriented slot 202. The slot 202 is positioned to accommodate connection of a tag 228 (FIGS. 18 to 20) to the waistband 82 of the harness 80, 100, 140 and 260 (FIG. 20).

In FIGS. 16 and 17, reference numeral 210 generally indicates an exemplary embodiment of a support device for a fall arrest harness. With reference to the preceding drawings, like reference numerals refer to like parts, unless otherwise specified. The use of common reference numerals is not intended to limit the scope of the appended claims and is for the purpose of convenience only. Furthermore, it is to be understood that components from previous embodiments and this embodiment can be interchanged, where practical, to provide further embodiments of a support device.

The lower portion 18 of the support device 210 is truncated to suit fall arrest harness designs that have a rear, Y-shaped webbing arrangement as shown in FIG. 19. Thus, the support device has an overall height or length (L4) of between about 330 and 380 mm.

Thus, the support device 210 does not include the lower engagement zones 26, which would be superfluous.

The support device 210 has similar dimensions to the support device 10. However, the truncated base portion 18 has an overall width of between 195 mm and 230 mm (W3). Also, a depth (D3) of the dorsal member is between about 38 and 45 mm, for example between about 41 and 42 mm.

In FIG. 18, reference numeral 220 generally indicates an exemplary embodiment of a support device for a fall arrest harness. With reference to the preceding drawings, like reference numerals refer to like parts, unless otherwise specified. The use of common reference numerals is not intended to limit the scope of the appended claims and is for the purpose of convenience only. Furthermore, it is to be understood that components from previous embodiments and this embodiment can be interchanged, where practical, to provide further embodiments of a support device.

Instead of two straps 58.1, 58.2, the support device 220 includes a single strap 222 that extends through the slots 24.1, 24.2 via a loop 224 in a dorsal D-ring 226. The strap 222 is secured to the dorsal member 12 with the fastening strips 60, as previously described with reference to the support device 40, 70.

The tag 228 is connected to the loop 224 of the D-ring 226 and extends through the slot 202. A fastening strip 230 is stitched to the tag 228 to fasten the tag to the dorsal member 12.

An adjustment buckle 232 is connected to the tag 228 so that a length of webbing 234 stitched to the belt webbing 84 can be used to connect the support device 200 to a waistband of a harness.

In this embodiment, a cushioning member 236 is also provided. As with the cushioning member 42, the cushioning member 236 has a top pocket 238 in which the neck support member 14 can be received. The cushioning member 236 also has a bottom pocket 240 in which the lower engagement zones 26 can be received to retain the cushioning member 236 in position.

In FIG. 19, reference numeral 250 generally indicates an exemplary embodiment of a support device for a fall arrest harness. With reference to the preceding drawings, like reference numerals refer to like parts, unless otherwise specified. The use of common reference numerals is not intended to limit the scope of the appended claims and is for the purpose of convenience only. Furthermore, it is to be understood that components from previous embodiments and this embodiment can be interchanged, where practical, to provide further embodiments of a support device.

The cushioning member 236 of the support device 250 is shortened to suit the device 210. A lower edge 242 of the dorsal member 12 of the device 210 can be received in the bottom pocket 240 to retain the cushioning member 236 in position.

In FIG. 20, reference numeral 260 generally indicates an exemplary embodiment of a fall arrest harness. With reference to the preceding drawings, like reference numerals refer to like parts, unless otherwise specified. The use of common reference numerals is not intended to limit the scope of the appended claims and is for the purpose of convenience only. Furthermore, it is to be understood that components from previous embodiments and this embodiment can be interchanged, where practical, to provide further embodiments of a fall arrest harness.

As mentioned above, the fall arrest harness 260 has the length of webbing 234 stitched to the belt webbing 84 so that the support device 220 can be fastened to the harness 250 using the adjustment buckle 232.

It will be appreciated that the support device 250 can also be connected to the harness 260 in that fashion.

The term “generic side profile of a thoracic spine” is intended to describe a side profile or contour of the dorsal member, namely one that extends outwardly or back and then back inwardly or forwards so mimicking the thoracic spine. “Generic” is intended to convey a conventional human spinal shape, not one that has perhaps been altered by surgery or deformity. It follows that the profile may incorporate arcuate or curved portions to provide an ergonomic and natural shape of the dorsal member. The neck support member may also be shaped in such a manner.

Reference to “thoracic” and “cervical” is not intended to refer with a level of accuracy usually required in the medical field to particular regions of the spine. The intention is to provide a demarcation between a spinal neck region and a spinal dorsal region in which the spine is usually bowed outwardly, possibly with a recurve in a transition between the neck and dorsal regions. That profile can clearly be seen as mimicked in the dorsal member shown in the drawings. This would be distinct from a lumbar region in which the profile or contour would reverse its direction and extend outwardly. Furthermore, it is not envisaged that the dorsal member needs to cover the entire thoracic region.

The dorsal member is thus shaped to provide a generally continuous contact area with the dorsal region. This can help to provide the functionality referred to above.

It is envisaged that the various exemplary embodiments of the support device described herein can be used in various conditions where cradling or ergonomic support is required, either for a person's whole body or simply for the dorsal and neck regions. Furthermore, the support device can be used for the sole purpose of supporting the neck of a person. In other words, it is not strictly necessary that the support device be used with a harness. The reason for this is that the functionality of the profile described above of the neck support member and the dorsal member has a wide range of applications. These may include, but are not limited to, carrying of a person, whether together with a further device or simply with just the support device. The fact that the head can be supported against backward tilting and side to side movement provides a functionality that is particularly suited for carrying a person in a condition in which excessive movement of the head is undesirable. Furthermore, the profile provides a level of comfort and a feeling of safety to the person being carried. This can reduce anxiety and facilitate treatment of the person, should that person be injured. In the event that the person is unconscious, the careers or other personnel that might be conveying that person can use the support device to achieve a level of safety by reducing excessive movement of the head during conveyance or other manipulation.

Throughout the specification, including the claims, where the context permits, the term “comprising” and variants thereof such as “comprise” or “comprises” are to be interpreted as including the stated integer or integers without necessarily excluding any other integers.

It is to be understood that the terminology employed above is for the purpose of description and should not be regarded as limiting. The described embodiments are intended to be illustrative of the invention, without limiting the scope thereof. The exemplary embodiments described herein are capable of being practised with various modifications and additions as will readily occur to those skilled in the art.

Various substantially and specifically practical and useful exemplary embodiments of the claimed subject matter, are described herein, textually and/or graphically, including the best mode, if any, known to the inventor for carrying out the claimed subject matter. Variations (e.g., modifications and/or enhancements) of one or more embodiments described herein might become apparent to those of ordinary skill in the art upon reading this application. The inventor expects skilled artisans to employ such variations as appropriate, and the inventor intends for the claimed subject matter to be practiced other than as specifically described herein. Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the practice of the claimed subject matter.

The use of words that indicate orientation or direction of travel is not to be considered limiting. Thus, words such as “front”, “back”, “rear”, “side”, “up”, down”, “upper”, “lower”, “top”, “bottom”, “forwards”, “backwards”, “towards”, “distal”, “proximal”, “in”, “out” and synonyms, antonyms and derivatives thereof have been selected for convenience only, unless the context indicates otherwise. The inventor envisages that various exemplary embodiments of the claimed subject matter can be supplied in any particular orientation and the claimed subject matter is intended to include such orientations.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:
a. there is no requirement for the inclusion of any particular described or illustrated characteristic, function, activity, or element, any particular sequence of activities, or any particular interrelationship of elements;
b. no characteristic, function, activity, or element is “essential”;
c. any elements can be integrated, segregated, and/or duplicated;
d. any activity can be repeated, any activity can be performed by multiple entities, and/or any activity can be performed in multiple jurisdictions; and
e. any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Moreover, when any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate sub-range defined by such separate values is incorporated into the specification as if it were individually recited herein. For example, if a range of 1 to 10 is described, that range includes all values there between, such as for example, 1.1, 2.5, 3.335, 5, 6.179, 8.9999, etc., and includes all sub ranges there between, such as for example, 1 to 3.65, 2.8 to 8.14, 1.93 to 9, etc.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

1. A support device for a harness, the support device comprising
a dorsal member, the dorsal member being configured for arrangement on a dorsal region of a wearer and for operative engagement with the harness in a position in which the dorsal member is interposed between the harness and the dorsal region of the wearer, the dorsal member having an upper portion, a lower portion and an intermediate portion interposed between the upper and lower portions; and
a neck support member that extends from the upper portion of the dorsal member and is configured to support a neck of the wearer when the dorsal member is arranged on the dorsal region of the wearer, wherein
the dorsal member has a profile that corresponds to a generic side profile of a thoracic spine of the wearer and the neck member extends backwardly from the upper portion of the dorsal member, such that the dorsal member can distribute pressure exerted by the harness and the neck support member can cradle the neck and support the head in a tilted back condition.

2. The support device as claimed in claim 1, in which the dorsal member 12 has a side profile that extends back from the upper portion to the intermediate portion about one third to a half of a vertical length of the dorsal member and then forwards to the lower portion.

3. The support device as claimed in claim 1, in which the dorsal member has a narrowest width at the intermediate portion.

4. The support device as claimed in claim 1, in which the upper portion includes two upper harness engagement zones that are spaced and positioned to overlie, at least partially, respective scapula regions of the wearer, the harness engagement zones being configured for allowing the support device to be engaged with the harness.

5. The support device as claimed in claim 4, in which the upper harness engagement zones each define a slot through which straps of the harness can be threaded.

6. The support device as claimed in claim 1, in which the lower portion includes at least one lower harness engagement zone that is configured for allowing the support device to be engaged with the harness.

7. The support device as claimed in claim 6, in which the, or each, lower harness engagement zone defines a slot through which a component of the harness can be threaded.

8. The support device as claimed in claim 6, in which the lower portion includes two lower harness engagement zones that are spaced and positioned to overlie a lower region of a wearer's rib cage, the lower portion being bifurcated.

9. The support device as claimed in claim 1, in which the dorsal and neck support members together define a unitary construction.

10. The support device as claimed in claim 1, in which an overall vertical height or length of the device is between about 330 mm and 450 mm.

11. The support device as claimed in claim 1, in which an overall width of the device at the upper portion is between about 230 mm and 260 mm.

12. The support device as claimed in claim 1, in which an overall width of the device at the lower portion is between about 195 mm and 255 mm.

13. The support device as claimed in claim 1, which comprises
webbing that is fast with the dorsal member; and
connectors that are arranged on the webbing to facilitate connection of the webbing to the safety harness.

14. A fall arrest harness that comprises
a waist band;
a thigh support arrangement that is connected to the waist band to be positioned behind the thighs and between the buttocks and knees of a wearer, in use;
two straps, each strap being configured for operative engagement with a respective shoulder of the user and operatively connected to the waist band;
a recumbency mechanism that is operatively engaged with the waist band, the recumbency mechanism being connectable to a tether so that, in a fall arrest situation, the recumbency mechanism operates to place the wearer in at least a partially recumbent or seated position; and
a support device that comprises
a dorsal member, the dorsal member being configured for arrangement on a dorsal region of a wearer and in a position in which the dorsal member is interposed between the safety harness and the dorsal region of the wearer, the dorsal member having an upper portion, a lower portion and an intermediate portion interposed between the upper and lower portions; and
a neck support member that extends from the upper portion of the dorsal member and is configured to support a neck of the wearer when the dorsal member is arranged on the dorsal region of the wearer, wherein
the dorsal member has a profile to correspond to a generic side profile of a thoracic spine of the wearer and the neck member extends backwardly from the upper portion of the dorsal member, such that the dorsal member can distribute pressure exerted by the harness and the neck support member can cradle the neck and support the head in a tilted back condition.

15. The fall arrest harness as claimed in claim 14, in which the recumbency mechanism comprises a guide that is arranged on a front of the waist band and two seat straps each being connected, at one end, to the thigh support arrangement, the guide being configured to permit movement of the seat straps relative to the waist band and opposite ends of the seat straps being connectable to a safety lanyard or the like so that, in a fall arrest situation, the seat straps can facilitate placement of the wearer in the at least partially recumbent or seated position.

16. The fall arrest harness as claimed in claim 15, in which the straps are configured to extend over a pectoral and abdominal region of the wearer and are connected to the waist band so that the straps can also facilitate placement of the wearer in the at least partially recumbent or seated position.

17. The fall arrest harness as claimed in claim 15, in which the straps are each fastened to a work positioning connector which, in turn, is connected to the waist band.
